(19) United States
(12) Patent Application Publication
(10) Pub. No.: US 2009/0207877 A1
(43) Pub. Date: Aug. 20, 2009

(54) WALL ELEMENTS FOR WATER-COOLED, CURRENT-CONDUCTING ELECTRODE BEARING ARMS AND ELECTRODE BEARING ARMS PRODUCED FROM SUCH WALL ELEMENTS

(76) Inventor: Arndt Dung, Hagen (DE)

Correspondence Address: LOUIS VENTRE, JR, 2483 OAKTON HILLS DRIVE, OAKTON, VA, 22124-1530, US

(21) Appl. No.: 12/303,254

(22) PCT Filed: Jun. 13, 2007
(86) PCT No.: PCT/EP2007/005198

§ 371 Date: Dec. 3, 2008

(30) Foreign Application Priority Data
Jun. 13, 2006 (DE) 10 2006 027 648.5

(51) Int. Cl. H05B 7/101

(52) U.S. Cl. 373/98; 373/99

(57) ABSTRACT

The particular aim of the invention is cost-effective production of the wall elements for water-cooled, current-conducting electrode bearing arms, wherein wall elements have been developed which comprise a flat profile, which consists of an electrically conductive metal and into which at least one recess is incorporated on the side forming the outside of the electrode bearing arm, which recess extends over the length of the profile and is provided on the outside and the end side with a cover, which is combined with the flat profile by means of welding and provides a closed cooling channel, with in each case at least one inlet and at least one outlet for the cooling water flowing through the channel. The constituent parts of the wall elements can be produced in a cost-effective manner from continuous material, from which wall elements it is then also possible for electrode bearing arms to be produced in a cost-effective manner taking into consideration individual requirements for electrode bearing arms to be produced from the wall elements in terms of their dimensions.

Wall elements for water-cooled, current-conducting electrode support arms, and electrode support arms produced from such wall elements

The invention relates to wall elements for water-cooled, current-conducting electrode support arms, and electrode support arms produced from such wall elements.

Support arms for the electrodes of electric arc furnaces require water cooling, at least in the vicinity of the furnace vessel, due to the high temperatures resulting from the melting process. In this regard it has been proposed in the past to have water impinge on the electrode support arm itself, which is designed as a hollow body, and also to associate tubes, which conduct cooling water and pass through the support arm, with the electrode support arm which is designed as a hollow body (EP 0 061 612 B1, U.S. Pat. No. 3,602,624, U.S. Pat. No. 3,686,421). As a result of the direct impingement of cooling water on the interior of the electrode support arm which is designed as a hollow body, with consideration for the fact that the support arm must have sufficient buckling resistance, the dimensioning of the wall thickness of the support arm must be taken into account. The cooling which is also generally provided for the electrode tension bracket and the contact jaw requires independent feeding of cooling water to the electrode tension bracket and the contact jaw through tubes, associated with the electrode support arm, for supply and discharge of the cooling water for the electrode tension bracket and the contact jaw. For the cooling water feed it has also been recently proposed for the extruded wall elements forming the electrode support arm to be provided with boreholes for the circulation of cooling water (EP 0 594 272 B2). In this case the separate tubing systems which pass through the electrode support arm or which are combined with the support arm are dispensed with. However, the complex production of the extruded wall elements having closed channels provided therein for the cooling water circuit has proven to be disadvantageous. This approach is also costly, since the production of wall elements with differing dimensions and/or cross sections of the cooling water channels requires separate tools which pass through the wall elements.

On the basis of the current art, the object of the present invention is to design a more economical cooling system which is integrated into wall elements which form electrode support arms, and which also allows more flexibility with regard to the cross sections of the wall elements and the cooling water channels.

The object is achieved by using wall elements for water-cooled, current-conducting electrode support arms which according to the invention comprise a flat profile made of an electrically conductive metal, and into which at least one recess is incorporated on the flat side forming the outside of the electrode support arm, the recess extending over the length of the profile and being provided on the outer and end face sides with covers which are combined with the flat profile by welding and which result in a closed cooling channel, and which in each case have at least one inlet and at least one outlet for the cooling water flowing through the cooling channel.

Embodiments of the wall element according to the invention result from subclaims 2 through 7. Subclaims 8 through 11 are concerned with electrode support arms which may be produced from the wall elements according to the invention.

Manufacture of the wall elements according to the invention requires no special tool. The manufacturer of the electrode support arms is able to produce the components of the wall elements according to the invention, namely, the wall element having the recess and the cover thereof which forms the cooling channel, from economically obtainable continuous materials, using standard tools such as saws, milling cutters, welding units, and drills which are available to the manufacturer anyway, and also to combine the components of the wall elements, from which the electrode support arm is subsequently assembled on-site. In this regard it has also proven to be advantageous that, in order to be able to adapt to special applications, wall elements of differing widths and lengths, and therefore also wall elements having differing cooling channel cross sections, may be easily produced using the available tools. Producing the electrode support arms from wall elements according to the invention also results in the desired weight reduction of such electrode support arms.

The invention is explained in greater detail with reference to one exemplary embodiment in the drawings, which show the following:

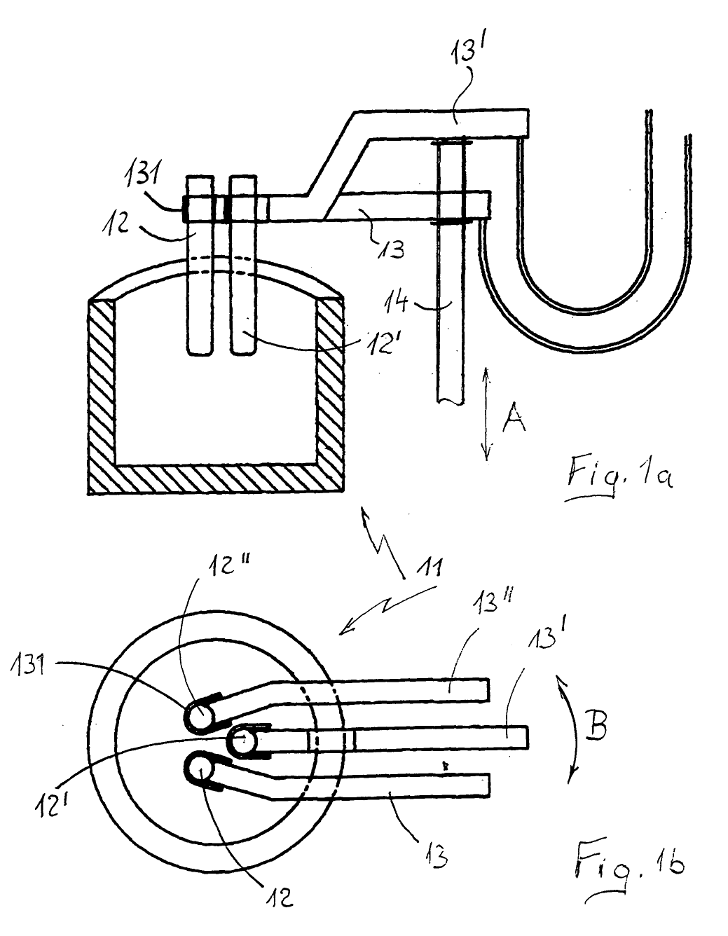

FIGS. 1a and 1b show the schematic illustration of an electric arc furnace melting unit;

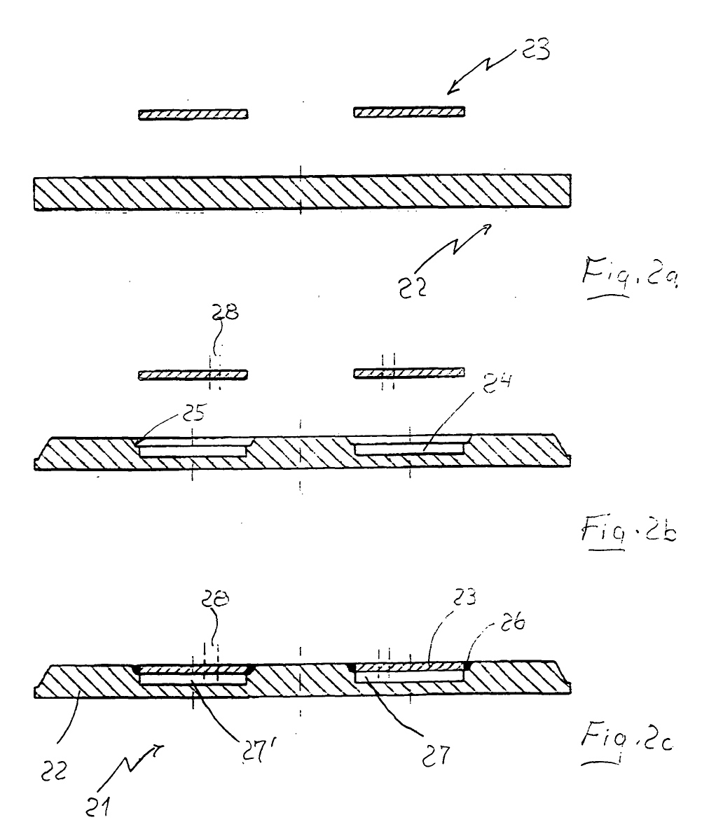

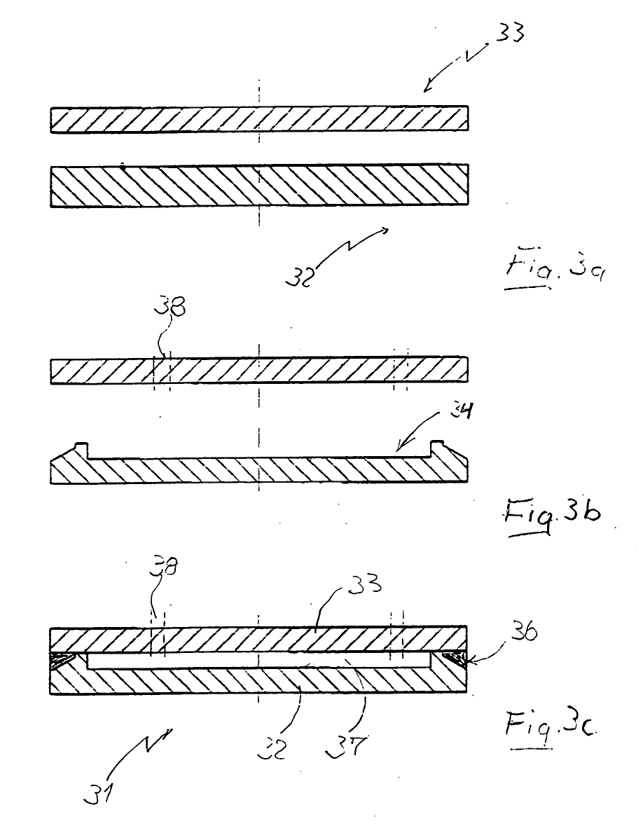

FIG. 2a shows the cut starting material for the side walls of the electrode support arm, in one cross section;

FIG. 2b shows an illustration corresponding to FIG. 2a, with recesses milled into the base body of the wall element;

FIG. 2c shows the completed wall element according to the invention;

FIG. 3a shows the cut starting material for the lower and upper wall elements of the electrode support arm, in one cross section;

FIG. 3b shows an illustration corresponding to FIG. 3a, with a recess milled into the base body;

FIG. 3c shows the completed wall element;

FIG. 4 shows a cross section, in the vicinity of the furnace vessel, of an electrode support arm produced from wall elements according to the invention; and

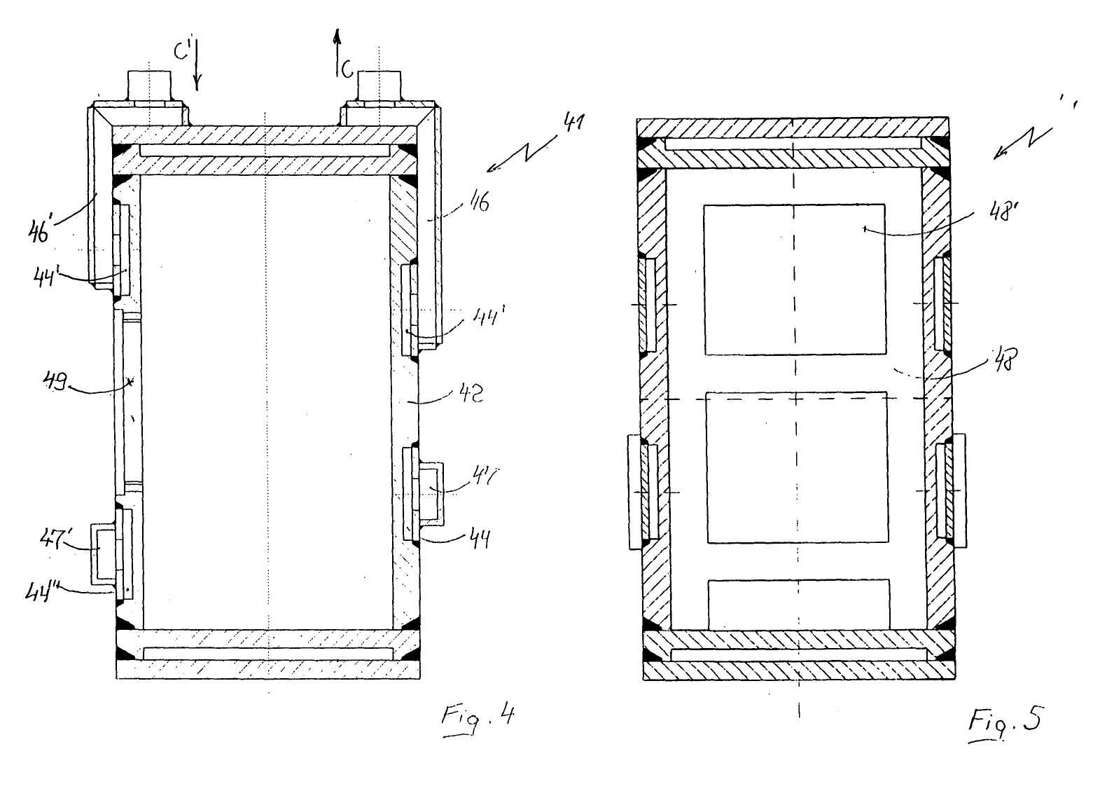

FIG. 5 shows a cross section corresponding to FIG. 4, in the vicinity of the furnace vessel, of the electrode support arm.

In the electric melting unit schematically illustrated in FIGS. 1a and 1b, reference numeral 11 denotes the furnace vessel in which the generally used scrap metal is melted under the influence of the electrodes 12, 12′, 12″ lowered into the furnace vessel. The electrodes 12, 12′ 12″ are clamped (131) to the free end of the electrode support arms 13, 13′, 13″, are lowered during the melting process corresponding to the progressive burnoff, and after advanced burnoff are replaced. For emptying of the furnace vessel 11 after the melting process is completed, generally by tilting the furnace vessel 11, as well as for replacement of the electrodes, the electrodes 12, 12′, 12″ must be lowered and raised, and then must be swiveled out of the immediate vicinity of the furnace vessel 11. For this purpose, the electrode support arms 13, 13′, 13″ are supported on a support arm column 14 so as to allow lowering and raising as indicated by double arrow A, and to allow horizontal swiveling as indicated by double arrow B. The electrode support arms and the tension brackets 131 for the electrodes 12, 12′, 12″ located at the free end of the electrode support arms 13, 13′, 13″ require intensive cooling, generally using cooling water which is led through the support arms and the tension brackets, due to the high temperatures occurring in the surroundings of the furnace vessel 11 during the melting process.

Components of the wall elements according to the invention for electrode support arms which are cut from continuous material are illustrated in FIGS. 2a and 3a. These components comprise the base bodies 22 which form the wider side walls, the base bodies 32 of lesser width which form the lower and upper walls of the electrode support arms, and the low-thickness covers 23, 23′, and 33 which complete the wall elements. FIGS. 2b and 3b show the respective base bodies 22 and 32 of the wall elements 21 and 31 with milled-in recesses 24 and 34. FIGS. 2c and 3c show the respective completed wall elements 21 and 31 together with the cooling water channels 27, 27′, and 37 provided therein. The remaining combination of the covers 23 with the base body 21 [sic; 22] of the wall element 21 by means of indented (25) welding seams 26 is shown in FIG. 2c. The components of the remaining wall element 31 shown in FIG. 3c are combined in a corresponding manner. The covers 23, 23′, and 33 (indicated in dashed lines) have respective boreholes 28 and 38 as required for connecting inlet, outlet, and transfer lines for the water flowing through the cooling channels 27, 27′, and 37.

In the cross section of an electrode support arm 41 produced from wall elements according to the invention in the furnace vicinity shown in FIG. 4, the wall elements forming the side walls of the electrode support arm are denoted by reference numerals 42, 42′, and the wall elements forming the lower and top sides of the electrode support arm are denoted by reference numerals 43, 43′. Cooling water which impinges on the support arm as well as the electrode tension bracket passes through the cooling channels 44 . . . , 44′″ provided in the side walls 42, 42′. The feed and discharge of the cooling water to and from the electrode tension bracket (not illustrated) is indicated by the arrow sequence C-C′. In a special case, the side walls 42, 42′ and the wall elements 43, 43′ forming the lower side and top side of the electrode support arm, as well as the electrode tension bracket and the contact jaw, are independently impinged with cooling water. However, the cooling water impingement may also be jointly combined via corresponding branches provided in the cooling channels of the side walls. Reference numerals 46, 46′ denote the furnace-side connections for the cooling water circuit in the electrode tension bracket which are situated at the cooling channels 44′, 44″ in the side walls 42, 42′. Connections for branches of one section with one of several other sections of the cooling channels 44 . . . , 44′″ which extend over the length of the side walls and which are divided into sections are denoted by reference numerals 47, 47′. The region denoted by reference numeral 49 is the modification region of the electrode support arm which may be added.

FIG. 5 shows the reinforcement of the electrode support arm by means of partitions 48 inserted into same, which are provided with cutouts 48′ for the purpose of weight reduction. The design of the wall thicknesses of the electrode support arm depends on the particular application, and also on the design of the cooling channel cross sections.

The preferential cooling of the electrode support arm via the cooling channels provided in the support arm walls does not exclude cooling of the region of the electrode support arm adjoining the furnace via the feeding of cooling water into partitioned regions in the vicinity of the furnace. The cooling water circuit also results from inlets and outlets for channels which extend in walls of the electrode support arm and which conduct the cooling water.

### LIST OF REFERENCE NUMERALS

11 Furnace vessel

12, 12′, 12″ Electrodes

13, 13′, 13″ Electrode support arms

131 Clamps, tension bracket

14 Support arm column

21 Wider wall element

22 Base body

23 Cover

24 Recess

25 Depression

26 Welding seams

27, 27′ Cooling channels

28 Boreholes

31 Narrower wall element

32 Base body

33 Cover

34 Recess

36 Welding seam

37 Cooling channel

38 Boreholes

41 Electrode support arm

42, 42′ Side walls

43, 43′ Base and top walls

44 . . . , 44′″ Cooling channels

45 Welding seams

46, 46′ Furnace-side connections

47, 47′ Additional connections

48 Partitions

48′ Cutouts

49 Modification region

A Support arm lift

B Support arm swivel

C Cooling water feed

C′ Cooling water return

1. Wall element for a water-cooled, current-conducting electrode support arm, characterized in that the wall element comprises a flat profile (22, e.g.) made of an electrically conductive metal, and into which at least one recess (24, e.g.) is incorporated on the side forming the outside of the electrode support arm, the recess extending over the length of the profile and being provided on the outer and end face sides with a cover (23, e.g.) which is combined with the flat profile (22) by welding (26, e.g.) and which results in a closed cooling channel (27, e.g.), and which in each case has at least one inlet and at least one outlet (28, e.g.) for the cooling water flowing through the channel (27).

2. Wall element according to claim 1, characterized in that the wall element is made of aluminum or an aluminum alloy.

3. Wall element according to claim 1 or 2, characterized in that the cover (23) results in a flat outside wall of the electrode support arm and is inserted in depressions (25) formed in the boundary region of the recess (24).

4. Wall element according to claims 1 through 3, characterized by widths which are matched to the cross section of the electrode support arm.

5. Wall element according to claims 1 through 4, characterized by a material thickness of the wall element in the range of 20 to 70 mm.

6. Wall element according to claims 1 through 5, characterized by a plurality of cooling channels (27, 27′) extending at a distance from one another over the length of the wall element (21, e.g.).

7. Wall elements according to claims 1 through 6, characterized in that connections for the impingement of cooling water on the electrode tension bracket to be mounted on the support arm are provided in the region of the area of the wall element which forms the free end of the electrode support arm.

8. Water-cooled, current-conducting, box-shaped electrode support arm formed from wall elements according to one or more of claims 1 through 7, characterized by stabilizing webs which are inserted at a distance from one another inside the electrode support arm and are supported on the wall elements.

9. Electrode support arm according to claim 8, characterized by partitions (48) which are inserted into the electrode support arm (41) at a distance from one another and are supported on the wall elements of the electrode support arm, and which stabilize the support arm.

10. Electrode support arm according to claim 9, characterized in that the partitions (48) are provided with a cutout (48′) which forms a frame.

11. Electrode support arm according to claims 8 through 10, characterized in that the abutting wall elements which form the electrode support arm are joined together in the abutment region by means of indented welding seams (45).
